(19) United States
(12) Patent Application Publication
(10) Pub. No.: US 2016/0060941 A1
(43) Pub. Date: Mar. 3, 2016

(54) Coaxially Extending Arm for Door Closing Operator

(71) Applicants: Wesley G. Ingham, Oklahoma City, OK (US); Gary Glenwood Ingham, Oklahoma City, OK (US)

(72) Inventors: Wesley G. Ingham, Oklahoma City, OK (US); Gary Glenwood Ingham, Oklahoma City, OK (US)

(21) Appl. No.: 14/475,717

(22) Filed: Sep. 3, 2014

(51) Int. Cl. E05F 15/63; E05F 15/53; E05F 15/60

(52) U.S. Cl. CPC E05F 15/63; E05F 15/60; E05F 15/53

(57) ABSTRACT

An arm for connecting a mounting foot to a motor in a door closer system having two segments between which a junction is formed that allows the segments low-friction coaxially-restricted extension and retraction motions relative to each other. A motor shaft connection at the attachment end of the first arm segment transmits rotational force from a shaft of a door closer motor, and a mounting foot at the opposite end of the second arm segment communicates the rotational force from the first arm segment to the mounting foot.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

None.

### MICROFICHE APPENDIX

Not applicable.

### INCORPORATION BY REFERENCE

None.

### FIELD OF THE INVENTION

The present invention relates to devices and systems for automatically closing doors.

### BACKGROUND OF INVENTION

Many doors are provided with a device to automatically close them after they are opened. Such automatic closing is desirable in order to save energy (e.g., loss of building heat or cooling), enhance security (e.g., make sure door is fully closed and locked), and increase convenience of those who pass through the door.

There are three general types of door closers on the market and in use: (a) closer operators which mount to the top outside surface of a door and have an engagement arm that connects to the door frame, (b) closer operators which mount to the door frame and have an engagement arm that connects to the door, and (c) closers which are hidden within the door, the door header, or within the hinges of the door.

External closers of types (a) and (b) are most common as they can be added to any door, provided there is adequate clearance for their mechanism to operate unimpeded. External closers are also desirable because they can be serviced and adjusted more easily than internal closers. The closing “motor” can be passive, such as a pneumatic, hydraulic, spring-based device or a combination of these, which is charged by opening the door, and discharged through the closing operation. Other external closers are electrical in nature, using energy from a battery or power mains to energize an electric motor or electromagnets to provide force to close the door.

“Hold-open” devices is another class of mechanisms which can be installed on a window or door to mechanically hold it open in a secure manner, even when wind may try to slam it shut. Some door closers have a stop mechanism that allows them to also operate as a hold-open device, while others don't.

Many of the built-in hold-open mechanisms of door closers will disengage if the door is slightly opened further than the hold-open position, which is the intended user control to release the hold-open operation. This may also occur, however, when a gust of wind catches the door, thereby inadvertently disengaging the hold-open mode and allowing the door to automatically shut. If the door is automatically locked, this can lead to people being locked out of the door by accident, such as when a crew is moving furniture or goods in and out of a locked security door. For this reason, separate hold-open devices are often provided, such as the simplest device (a door stop wedge or trash can) ranging to more secure devices (locking props, etc.).

### SUMMARY OF THE INVENTION

Embodiments provide an arm for connecting a mounting foot to a motor in a door closer system having two segments between which a junction is formed that allows the segments low-friction coaxially-restricted extension and retraction motions relative to each other. A motor shaft connection at the attachment end of the first arm segment transmits rotational force from a shaft of a door closer motor, and a mounting foot at the opposite end of the second arm segment communicates the rotational force from the first arm segment to the mounting foot.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 illustrates an exemplary embodiment of an assembled door closer arm, separate from a door closer motor.

FIG. 2 depicts a typical door closer of the prior art which uses an articulating (elbowed) arm in which the closer motor is attached to the door.

FIG. 3 shows a similar prior art closer with articulating arm, except in an installation configuration in which the closer motor is mounted on the door frame instead of on the door.

FIG. 4 shows an arm embodiment example according to the present invention in an installation configuration similar to that of FIG. 3, and the advantages of the extendable arm over the articulated arm can be seen.

FIG. 5 illustrates an arm embodiment example according to the present invention in an installation configuration similar to that of FIG. 2 (motor mounted on the wall), and, again, the advantages of the extendable arm over the articulated arm can be seen.

FIG. 6 illustrate the length changes of an arm according to the present invention as a door moves or “sweeps” through its closed and open positions.

FIG. 7 sets forth a partially-disassembled arm into two sections, each with their respective attachment hardware.

### DETAILED DESCRIPTION OF EMBODIMENT(S) OF THE INVENTION

The present inventors have recognized a problem in the art which is currently unrecognized and unsolved. Most externally-mounted door closers employ an articulated closer arm which extends from the closer motor output to a terminus, where one of the terminus or motor is connected to the door, and the other (terminus or motor) is connected to the door frame, wall, or floor.

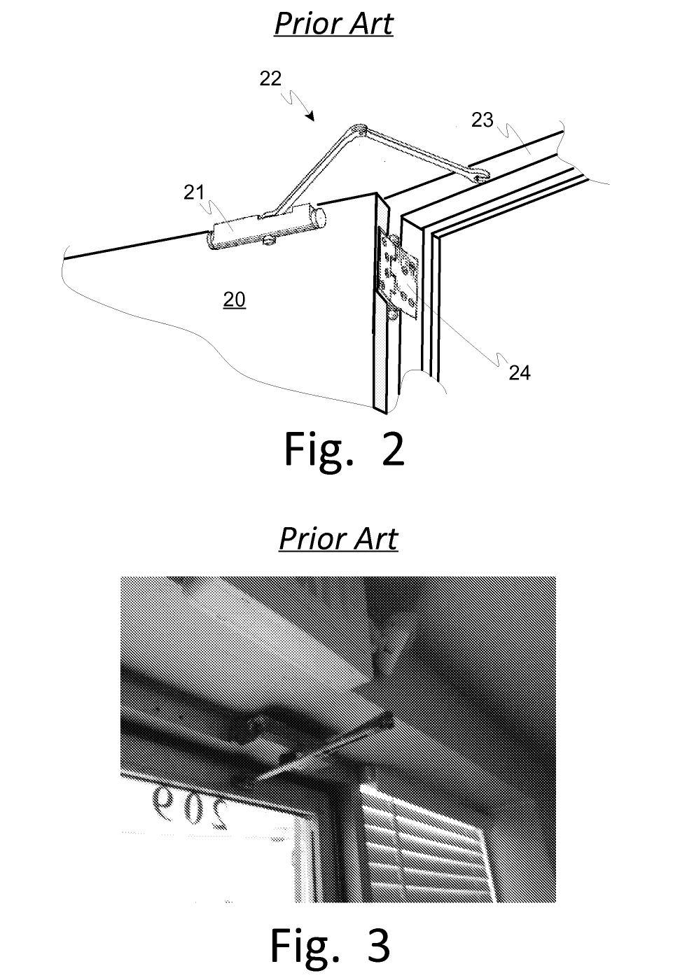

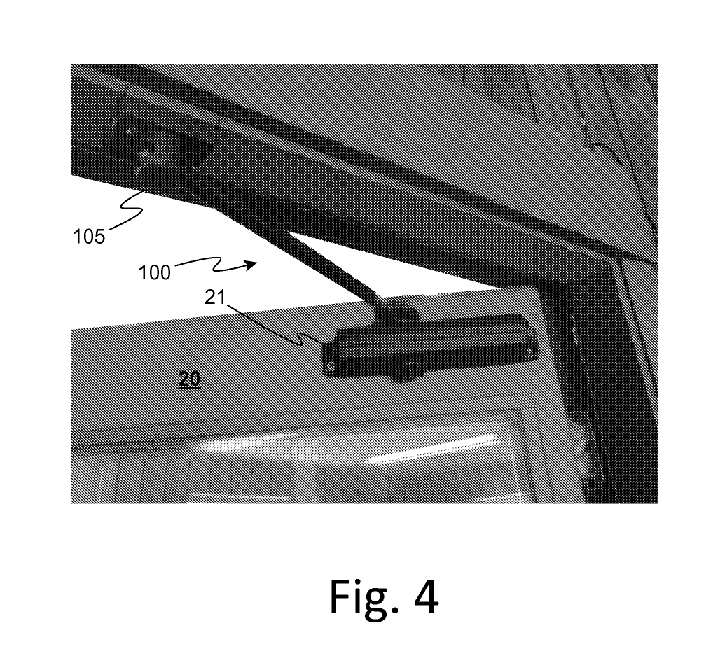

Referring to FIG. 2, a typical door closer with articulating arm is shown. In this configuration, the closer motor (21) is attached directly to a door (20, partially shown), and to one end of a closer arm (22). Via an elbow in the articulated arm (22), the system is connected to a door frame (23), wall or floor. Within the housing of the motor (21) is an electric motor, pneumatic actuator or spring which provides rotational force to a shaft on which the arm (22) is attached. The motor is charged, such as by opening the door, and when the door is released, the motor shaft rotates the first (left-most) segment of the arm such that the elbow end of the first segment moves from left to right in this diagram. Through the second (right-most) segment of this arm, the force is translated to the door frame as a pulling force, thereby causing the door (20) to rotate about the hinge(s) (24) towards a position to be received into the frame (23, partially shown), e.g. closed. Motors can be more or less sophisticated, offering different amounts of closing force and speed through the full range of motion, such as to close quickly through most of the range of motion but to slow down in the last few inches of closure (e.g., soft finish).

In other configurations, the motor (21) may be mounted on the wall or door frame, and the far end of the closing arm may connect directly to the door, such as the photograph of FIG. 3.

The inventors have realized, however, that the articulating arm requires space in which to exist when the door is fully closed which can be problematic. In many configurations, this arm protrudes from the wall and closed door almost perpendicularly by the length of the half-arm segments. Thus, some construction limitations may limit whether or not a door closer can be used, such as a door which is adjacent to a corner wall, etc., because the closer arm may run into another structural member at some point in the range of motion.

Further, the present inventors have realized that, because the physics of the force from the motor to the far-end attachment point via the articulating arm becomes complex depending on the positioning of the far-end attachment point relative to the position of the motor mount, many installers may incorrectly install the closer. There are often one or more adjustments on the motor, but it can be frustrating to installers and users because these adjustments often cannot compensate for a wrongly-positioned far-end arm attachment. So, while such a mechanism seems straightforward in proposition, the reality of the problem is much more complex.

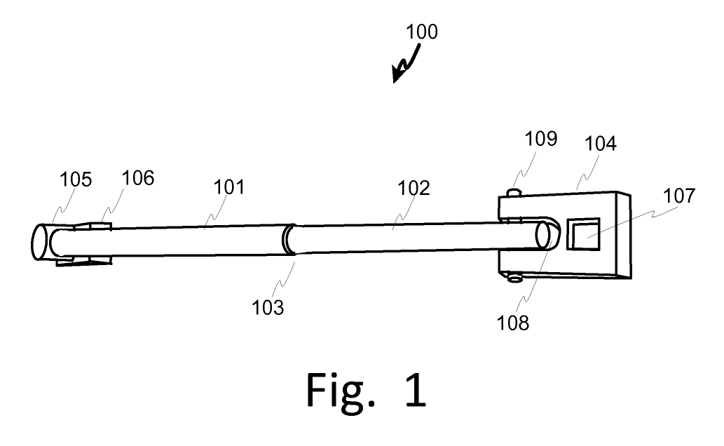

Coaxially Extendable Door Closer Arm. Referring now to FIG. 1, one particular embodiment according to the present invention is shown for an axially extendable arm for a door closer which avoids the use of an elbow (e.g., non-articulating). In this exemplary embodiment, a sliding junction (103) is formed between two members (101, 102) such as by having first member (101) receive internally the second member (102). This embodiment includes a substantially hollow first member (101) having an internal diameter to receive a similarly-shaped second member (102). In one embodiment, there is no pneumatic action between the two members, they just slide relative to each other to provide an extendable arm along a common axis. In this example, the cross-sectional shape of these members is round, but other interlocking shapes may be employed, e.g., C interlocking with a T, two squares, rectangles, etc.

One of the members, the first member (101) in this example, is provided at an opposite end of the junction (103) with a pivoting mounting foot (105, 106) for attachment to a door, door frame, wall or floor. The other member, the second member (102) in this example, is provided at an opposite end of the junction (103) a pivotal attachment to a motor shaft connection (104).

The mounting foot has a receiver (105) for an arm member (101 in this example), which pivots relative to an attachment foot (106). The attachment foot may be provided with one or more mounting orifices for receiving a bolt or screw for attachment to a door frame, wall, door, or floor.

The motor shaft connection (104) has an orifice (107) for receiving a drive shaft from a closer motor, a slot (108) for receiving an end of an arm member (102 in this example), and a retention device (109), such as a pin, for pivotally capturing the end of the arm in the slot.

Manner of Use and Operation.

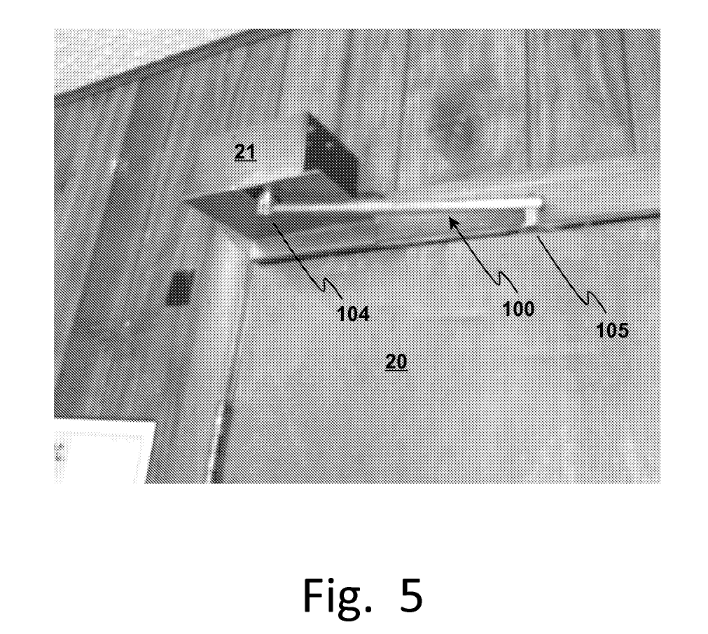

In practice, the arm may be used with many different motors, optionally to replace an articulating arm, by attaching the motor shaft connection (104) to the output of a closer motor. Then, the motor is attached to a door or wall, door frame, or floor. If the motor is attached to a door, then the mounting foot (105) is attached to a wall, door frame or floor. If the motor is attached to a wall, door frame or floor, then the mounting foot (105) is attached to the door. FIG. 5 shows an example of the latter configuration (motor mounted to door frame, opposite end of the arm attached to the door).

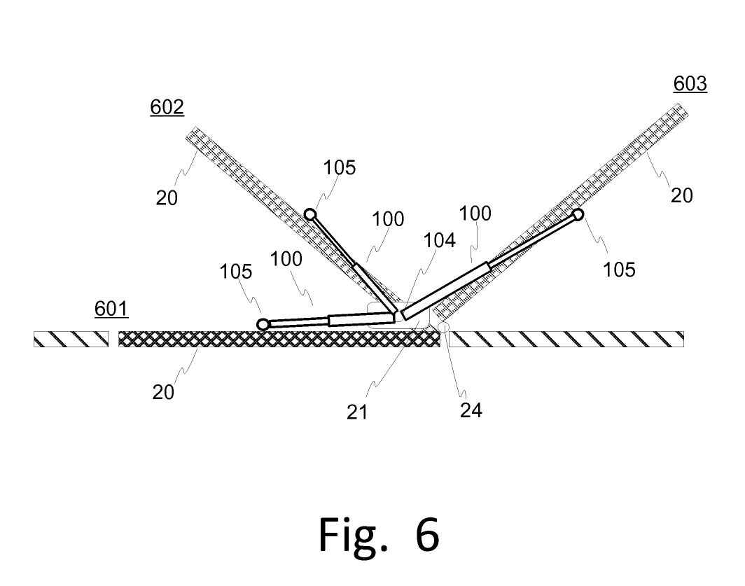

Referring now to FIG. 6, when an embodiment according to the invention is in a closed door position (601), the arm (100) is extended to a first length while the first and second arm members are still fully engaged with each other. As the door (20) is partially opened (602), the door pivots about the pin in the hinge (24), and the arm (100) shortens to a second length as the mounting foot (105) nears the motor shaft connection (104). As the door (20) travels further to an opened position (603), the length of the arm (100) extends again because the mounting foot moves away from the motor shaft connection. The improved arm (100) is attached to a conventional door closer motor, so at this opened position (603), the motor is fully charged and ready to apply closing force, e.g. counter-clockwise motion as viewed in FIG. 6.

So, after the door is released by the user or unblocked by a hold-open device, the motor shaft begins to be forced counter-clockwise, which places rotational force on the section of the closer arm closest to the motor. Because the farther section is coaxially engaged with the closest section, this sweeping force is transmitted to the second arm section and applied to the pivot of the mounting foot (105). This causes the door to swing counter-clockwise until it reaches the closed position (601) again.

Construction Benefits.

Please note that at no time during the opening or closing process did the closer arm articulate, bend, or otherwise inhabit space other than a substantially linear space extending from the motor's shaft to the connection point at the far end of the arm. In this way the arm can be used on doors in any construction scenario—near corners, near other doors, etc.

In fact, unlike the articulating arm, the coaxially extending arm can be installed with door closers on doors which are intended to open entirely and lay flat against the wall.

Manual Disengagement.

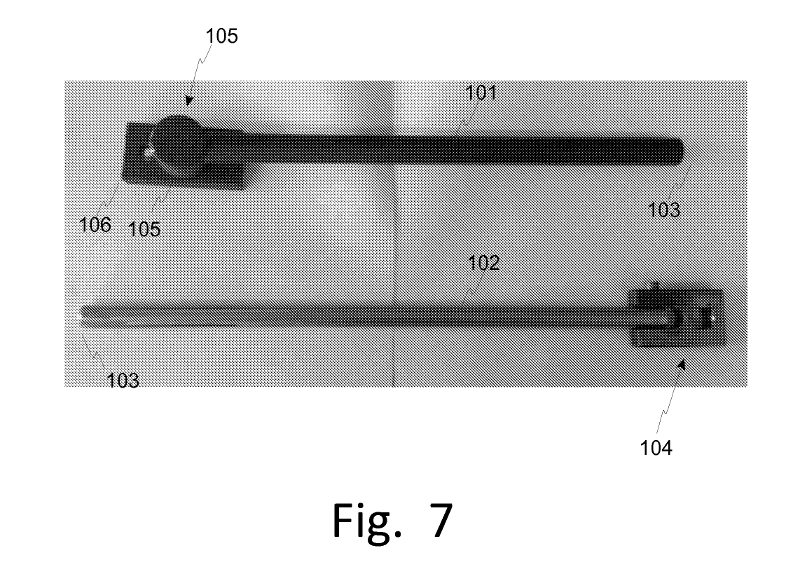

In at least one available embodiment, the closer arm sections may be slid apart from each other while the door is held fully open so that the motor is disconnected from the far-end attachment point. In this way, without tools, a user can temporarily disengage the closer's operation and allow the door to operate freely. Then, just as easily, the user can open the door again and re-engage the two sections of the closer arm so that normal operation can resume. For reference, FIG. 7 shows the two arm segments disengaged from each other, and in this particular image, unattached from the door, door frame and motor.

Installation Benefits. Because the length of the arm can be set to a minimum by the length of the two sections (e.g., the minimum length of the arm assembly would be at least the length of the longest section plus the length of the mounting foot), or by providing a détente (pin, finger, etc.) in the sliding path of the section which is received, correct installation can be ensured because the installer is not required to know who much bend to place in the elbow of an articulated arm. Thus, when the improved coaxially-extending arm is installed, proper leverage and force application is reliably achieved because the attachment point for the far-end of the arm is obvious—simply where it falls on the frame or door after being attached to the motor shaft. This allows the adjustments on the motor to be used for their intended purpose (e.g. speed and force of closing), instead of being used to overcome leverage problems due to incorrect closer arm installation.

Alternative Materials and Construction Methods.

Other embodiments may use other materials and different construction configurations within the scope of the present invention. For example, instead of using round tubing stock to create the arm segments, other shaped stock may be used. Or, one segment may be substantially C-shaped forming a channel for reception of a T-shaped segment. Combinations of these alternatives are also available.

In at least one available embodiment, one section is received in the other section in a low-friction manner, thereby providing a passive extension and retraction mechanism which is driven by the movement of the door and the position of the motor. In other embodiments, the coaxially extendable arm may be provided with resistance, such as a hold-open pin, clip or clamp.

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. An arm for connecting a mounting foot to a motor in a door closer system comprising:
a first arm segment having a junction end and an attachment end;
a second arm segment having a junction end and an attachment end;
a junction formed between the first and second arms at the junction ends which allows the segments low-friction coaxially-restricted extension and retraction motions relative to each other;
a motor shaft connection disposed at the attachment end of the first arm segment for transmitting rotational force from a shaft of a door closer motor; and
a mounting foot disposed at the attachment end of the second arm segment for communicating the rotational force from the first arm segment via the junction to the mounting foot.

2. The arm as set forth in claim 1 wherein the first arm segment is received into the second arm segment to form the junction.

3. The arm as set forth in claim 1 wherein the second arm segment is received into the first arm segment to form the junction.

4. The arm as set forth in claim 1 wherein the mounting foot is configured for attachment to a static building element.

5. The arm as set forth in claim 4 wherein the static building element is selected from the group consisting of a door frame, a wall, a floor, and a window.

6. The arm as set forth in claim 1 wherein the mounting foot is configured for attachment to a door.

7. The arm as set forth in claim 1 further comprising a détente element for limiting a maximum extended length of the arm.

8. The arm as set forth in claim 1 further comprising a détente element limiting a minimum retracted length of the arm.

9. The arm as set forth in claim 1 further comprising a hold-open element for locking the arm in a selected length of extension.

10. A method of manufacture of an arm for connecting a mounting foot to a motor in a door closer system comprising:
forming a first arm segment having a junction end and an attachment end;
forming a second arm segment having a junction end and an attachment end;
engaging the first arm segment to the second arm segment at the junction ends to allow low-friction coaxially-restricted extension and retraction motions relative to each other;
disposing a motor shaft connection at the attachment end of the first arm segment for transmitting rotational force from a shaft of a door closer motor; and
disposing a mounting foot at the attachment end of the second arm segment for communicating the rotational force from the first arm segment via the junction to the mounting foot.

11. The method as set forth in claim 10 wherein the engaging comprises receiving the first arm segment into the second arm segment to form the junction.

12. The method as set forth in claim 10 wherein the engaging comprises receiving the second arm segment into the first arm segment to form the junction.

13. The method as set forth in claim 10 wherein the mounting foot is configured for attachment to a static building element.

14. The method as set forth in claim 13 wherein the static building element is selected from the group consisting of a door frame, a wall, a floor, and a window.

15. The method as set forth in claim 10 wherein the mounting foot is configured for attachment to a door.

16. The method as set forth in claim 10 further comprising providing a détente element for limiting a maximum extended length of the arm.

17. The method as set forth in claim 10 further comprising providing a détente element limiting a minimum retracted length of the arm.

18. The method as set forth in claim 10 further comprising providing a hold-open element for locking the arm in a selected length of extension.
